(19) United States
(12) Patent Application Publication
(10) Pub. No.: US 2015/0027379 A1
(43) Pub. Date: Jan. 29, 2015

(54) Automatic Feeding Apparatus

(71) Applicant: Solis Hight-tech Inc. (Shenzhen) Ltd., Shenzhen (CN)

(72) Inventors: Chunhou Li, Shenzhen (CN); Liang Jie, Shenzhen (CN); Hongbiao Dong, Shenzhen (CN); Zhijun Liu, Shenzhen (CN); Jianbin Xiao, Shenzhen (CN); Yafei Duan, Shenzhen (CN); Xiaoyong Jie, Shenzhen (CN); Jiasong Zhang, Shenzhen (CN)

(21) Appl. No.: 14/341,857

(22) Filed: Jul. 28, 2014

(30) Foreign Application Priority Data
Jul. 29, 2013 (CN) 201310323748.0

(51) Int. Cl. A01K 5/00; A01K 5/02

(52) U.S. Cl. CPC A01K 5/004; A01K 5/02
USPC 119/57.92

(57) ABSTRACT

An automatic feeding apparatus includes a reaction container, and two or more dosing containers installed above the reaction container and having a feeding end extending into the reaction container. The reaction container has a water inlet formed on a sidewall of the reaction container and a siphon draining device installed at the bottom of the reaction container for discharging a liquid from the reaction container to the outside. The reaction container includes a mixer that divides the reaction container into an upper-layer reaction area and a lower-layer reaction area. Therefore, a liquid and/or a powder in the dosing container flows into the mixer, and then flows into water through the lower-layer reaction area and the water inlet for dilution. If the water level of the lower-layer reaction area exceeds the siphon level, the mixed liquid will be discharged out of the reaction container by the siphon effect.

### CROSS-REFERENCE TO RELATED APPLICATIONS

This non-provisional application claims priority under 35 U.S.C. §119(a) on Patent Application No(s). 201310323748.0 filed in China on Jul. 29, 2013, the entire contents of which are hereby incorporated by reference.

### BACKGROUND OF THE INVENTION

1. Field of the Invention

The present invention relates to an automatic feeding apparatus applied in the fields of biological farming, creature appreciation, and pet raising for feeding a material or medicine to control the reaction time and reduce the power consumption to a low or even zero level.

2. Description of the Related Art In biological farming, feeding is a necessary process for aquaculture, creature appreciation and pet raising as well as for manufacturing biological agents and medicines (including liquid and powder). When a biological agent or medicine is applied in a process of the biological farming, creature appreciation and pet raising, particularly in the starting process before using the biological agents, a feeder becomes a necessary device for adding a specific quantity of carbon to achieve the best activity and effect after waiting for a specific reaction time.

At present, various different feeders available in the market are mainly divided into two types, respectively: a manual feeder and an automatic feeder which is controlled by an electric power source, and the feeding process of the former totally relies on manpower and inevitably requires more labor efforts and a relatively longer wait; and the latter can achieve the effects of feeding materials automatically and controlling the quantity of fed material effectively, but it requires a complicate electronic circuit control and has the disadvantages of being affected by a wet environment or damaged easily and consumes much electric power. In addition, the conventional feeders (regardless of the manual or automatic ones) available in the market still have an issue of failing to dissolve, react, or mix the materials (medicines) sufficiently and thus resulting in a highly concentrated medicine being in contact with a living creature and causing a poor reaction. Therefore, it is a main subject for related manufacturers to upgrade the product technology by designing and developing a feeder capable of dissolving, reacting and mixing the materials or medicine sufficiently while feeding a material (medicine) automatically, and achieving the effect of minimizing the power consumption or even reducing the power consumption down to a zero level.

### SUMMARY OF THE INVENTION

In view of the problems of the prior art, it is a primary objective of the present invention to provide an automatic feeding apparatus capable of feeding a material (or medicine), controlling the reaction time, and reducing the power consumption (even down to a zero level).

To achieve the aforementioned objective, the present invention provides an automatic feeding apparatus, comprising: a reaction container; and two or more dosing containers, installed at the top the reaction container, and having a feeding end extending into the reaction container, and the reaction container having a water inlet formed on a sidewall of the reaction container and a siphon draining device installed at the bottom of the reaction container for discharging a liquid contained in the reaction container to the outside of the reaction container.

Wherein, the reaction container includes a mixer that divides the reaction container into an upper-layer reaction area and a lower-layer reaction area, and the upper-layer reaction area and the lower-layer reaction area are interconnected indirectly or directly, and feeding ends of the two or more dosing members extend into the mixer.

Wherein, at least one of the dosing containers with the feeding end extending into the mixer contains a liquid medicine.

Wherein, the mixer is a conical funnel, and the conical funnel has a thread structure formed at an opening at the middle of the conical funnel to define a spiral liquid mixing space.

Wherein, the mixer is a conical funnel, and at least one mixed liquid siphon pipe is installed at the bottom of the mixer, and the upper-layer reaction area and the lower-layer reaction area are interconnected through the mixed liquid siphon pipe.

Wherein, the siphon draining device is comprised of at least one siphon pipe, and an end of the siphon pipe abuts the bottom of the lower-layer reaction area, and the other end of the siphon pipe is extended from a mid-high position of the lower-layer reaction area and then bent for at least once and passed through the bottom wall of the reaction container, and finally extended to the outside of the reaction container.

Wherein, the siphon pipe is passed out from an end of the bottom wall of the reaction container and perpendicular to the bottom wall.

Wherein, the dosing container has an outlet end installed with a flow control valve. Wherein, the water inlet is installed at a mid-high position of a sidewall of the lower-layer reaction area, and the position of the water inlet is higher than the highest bending point of the siphon pipe, and the water inlet has a water inlet pipe and a water regulating valve installed thereon.

In summation, the present invention has the following advantages and effects: In the present invention, the feeding end of the dosing container is extended into the reaction container directly, so that a liquid machine may be dissolved, reacted and mixed sufficiently in the reaction container and then discharged to the outside through the siphon draining device. In addition, a mixer is installed to divide the reaction container into an upper-layer reaction area and a lower-layer reaction area, so that a liquid and/or a powder contained in the dosing container flows into the mixer due to its weight for a mixing process, and then flows into the lower-layer reaction area, and finally flows into water through a water inlet to dilute the mixed liquid. If the water level of the lower-layer reaction area exceeds the siphon level of the siphon draining device, the mixed liquid in the lower-layer reaction area will be discharged to the outside of the reaction container through a siphon effect. In a feeding process for the biological farming, the present invention controls the quantity of the dose and the feeding time. In the process of feeding one or more materials (medicine), the materials (medicines) are dissolved, mixed, reacted, and diluted sufficiently without requiring any power consumption, since the liquid pressure is used as power to complete the feeding process automatically.

### BRIEF DESCRIPTION OF THE DRAWINGS

FIG. 1 is a schematic view of an automatic feeding apparatus in accordance with a first preferred embodiment of the present invention;

FIG. 2 is a schematic view of an automatic feeding apparatus in accordance with a second preferred embodiment of the present invention;

FIG. 3 is a schematic view of an automatic feeding apparatus in accordance with a third preferred embodiment of the present invention;

FIG. 4 is a schematic view of an automatic feeding apparatus in accordance with a fourth preferred embodiment of the present invention.

### DETAILED DESCRIPTION OF THE PREFERRED EMBODIMENTS

The aforementioned and other objectives, technical characteristics and advantages of the present invention will become apparent with the detailed description of preferred embodiments and the illustration of related drawings as follows.

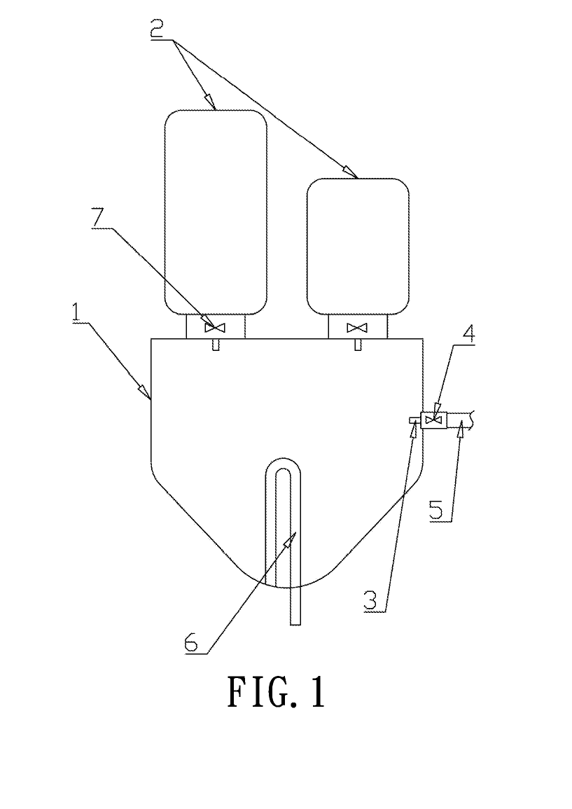

With reference to FIG. 1 for an automatic feeding apparatus of the first preferred embodiment of the present invention, the automatic feeding apparatus comprises a reaction container 1, and two or more dosing containers 2 installed at the top of the reaction container 1, wherein a feeding end of the dosing container 2 is extended into reaction container 1, and a water inlet 3 is formed on a sidewall of the reaction container, and a siphon draining device is installed at the bottom of the reaction container 1 for discharging a liquid from the reaction container 1 to the outside. By extending the feeding end of the dosing container 2 into the reaction container 1 directly, a liquid medicine may be mixed sufficiently and then discharged through the siphon draining device.

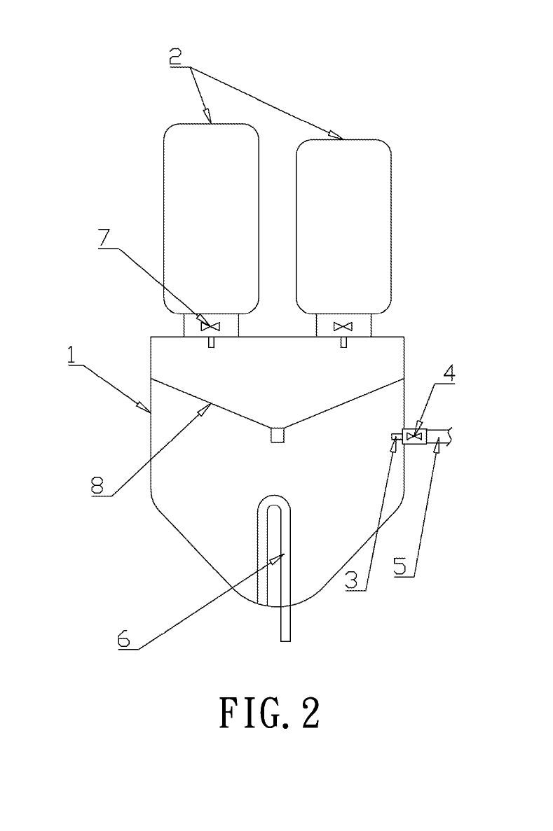

With reference to FIG. 2 for the second preferred embodiment of the present invention, the reaction container 1 includes a mixer 8 that divides the reaction container into an upper-layer reaction area and a lower-layer reaction area, and the upper-layer reaction area and lower-layer reaction area are interconnected indirectly or directly, and feeding ends of the two dosing containers 2 are extended into the mixer 8. The feeding end of at least one of the dosing containers 2 that is extended into the mixer 8 contains a liquid medicine. Powder medicines may be added into the other dosing containers 2, and the powder medicine may be dissolved in the liquid medicine. The mixer 8 is a conical funnel, and a thread structure is formed at an opening at the middle of the conical funnel to define spiral liquid mixing space. After two or more liquid medicines and/or powder medicines pass through the spiral liquid mixing space, they are dissolved, reacted, and mixed sufficiently.

The mixer 8 is installed to divide the reaction container 1 into an upper-layer reaction area and a lower-layer reaction area, so that after a liquid and/or a powder contained in the dosing container 2 flows into the mixer 8 by the effect of its own weight, the liquid and/or powder flows into the lower-layer reaction area, and then into water through the water inlet, so that the mixed liquid is diluted. If the water level of the lower-layer reaction area exceeds the siphon level of the siphon draining device, the mixed liquid contained in the lower-layer reaction area will be discharged from the reaction container to the outside. In a feeding process for the biological farming, the present invention controls the quantity of the dose and the feeding time. In the process of feeding one or more materials (medicine), the materials (medicines) are dissolved, mixed, reacted, and diluted sufficiently without requiring any power consumption, since the liquid pressure is used as power to complete the feeding process automatically.

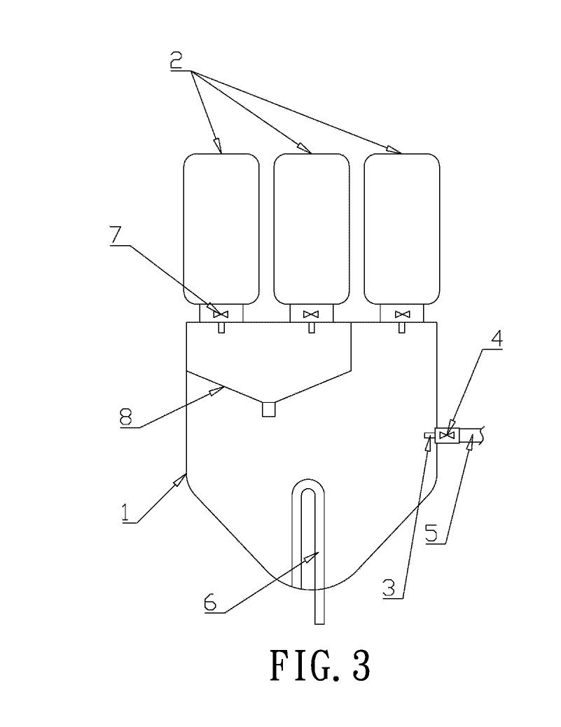

With reference to FIG. 3 for the third preferred embodiment of the present invention, the feeding ends of two dosing containers 2 are extended into the mixer 8, and the feeding end of one dosing container 2 is extended into the reaction container 1 directly.

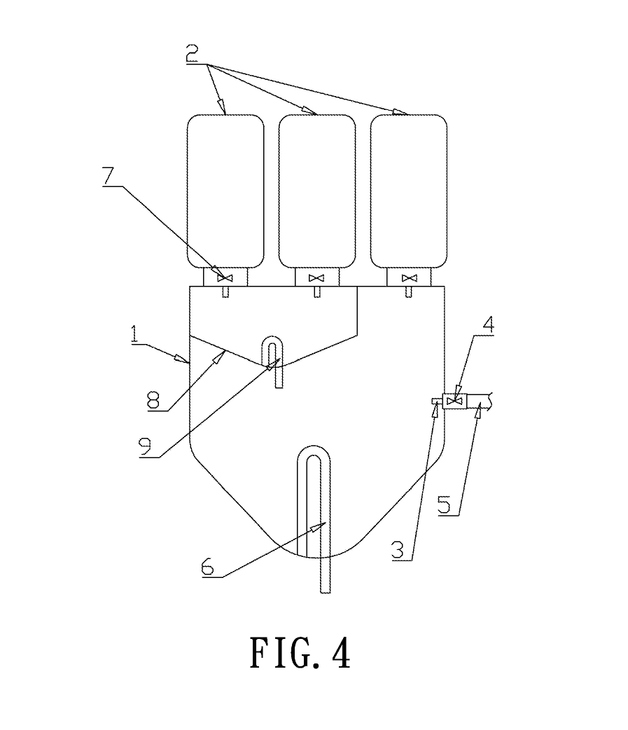

With reference to FIG. 4 for the fourth preferred embodiment of the present invention, the mixer 8 is a conical funnel, and at least one mixed liquid siphon pipe 9 is installed at the bottom of the mixer 8, and the upper-layer reaction area and the lower-layer reaction area are interconnected through the mixed liquid siphon pipe 9. If the level of liquid machine contained in the mixer 8 exceeds the siphon level of the mixed liquid siphon pipe 9, the liquid machine will flow into the lower-layer reaction area through the mixed liquid siphon pipe 9.

Preferably, the siphon draining device is comprised of at least one siphon pipe 6, and an end of the siphon pipe 6 abuts the bottom of the lower-layer reaction area, and the other end of the siphon pipe 6 is extended to a mid-high position of the lower-layer reaction area, and then bent for at least one time before passing through the bottom of the reaction container 1 and extending out from the reaction container 1. Preferably, the siphon pipe 6 is passed through and out from an end of the bottom wall of the reaction container 1 and perpendicular to the bottom wall, so that the liquid medicine discharged from the siphon pipe 6 enters into a liquid adding position perpendicularly.

Preferably, a flow control valve 7 is installed at the outlet end of the dosing container 2, and the flow control valve 7 installed on the dosing container 2 may be adjusted in order to mix the liquid medicines in a specific proportion.

Preferably, the water inlet 3 is installed at a mid-high position of a sidewall of the lower-layer reaction area, and the position of the water inlet 3 is higher than the highest bending point of the siphon pipe, and a water inlet pipe 5 and a water regulating valve 4 are installed onto the water inlet 3, and the water regulating valve 4 is provided for adjusting the quantity and inflow of water.

What is claimed is:

1. An automatic feeding apparatus, comprising:
a reaction container; and
two or more dosing containers, installed at the top the reaction container, and having a feeding end extending into the reaction container, and the reaction container having a water inlet formed on a sidewall of the reaction container and a siphon draining device installed at the bottom of the reaction container for discharging a liquid contained in the reaction container to the outside of the reaction container.

2. The automatic feeding apparatus of claim 1, wherein the reaction container includes a mixer that divides the reaction container into an upper-layer reaction area and a lower-layer reaction area, and the upper-layer reaction area and the lower-layer reaction area are interconnected indirectly or directly, and feeding ends of the two or more dosing members extend into the mixer.

3. The automatic feeding apparatus of claim 2, wherein at least one of the dosing containers with the feeding end extending into the mixer contains a liquid medicine.

4. The automatic feeding apparatus of claim 3, wherein the mixer is a conical funnel, and the conical funnel has a thread structure formed at an opening at the middle of the conical funnel to define a spiral liquid mixing space.

5. The automatic feeding apparatus of claim 3, wherein the mixer is a conical funnel, and at least one mixed liquid siphon pipe is installed at the bottom of the mixer, and the upper-layer reaction area and the lower-layer reaction area are interconnected through the mixed liquid siphon pipe.

6. The automatic feeding apparatus of claim 4, wherein the siphon draining device is comprised of at least one siphon pipe, and an end of the siphon pipe abuts the bottom of the lower-layer reaction area, and the other end of the siphon pipe is extended from a mid-high position of the lower-layer reaction area and then bent for at least once and passed through the bottom wall of the reaction container, and finally extended to the outside of the reaction container.

7. The automatic feeding apparatus of claim 6, wherein the siphon pipe is passed out from an end of the bottom wall of the reaction container and perpendicular to the bottom wall.

8. The automatic feeding apparatus of claim 6, wherein the dosing container has an outlet end installed with a flow control valve.

9. The automatic feeding apparatus of claim 6, wherein the water inlet is installed at a mid-high position of a sidewall of the lower-layer reaction area, and the position of the water inlet is higher than the highest bending point of the siphon pipe, and the water inlet has a water inlet pipe and a water regulating valve installed thereon.

10. The automatic feeding apparatus of claim 5, wherein the siphon draining device is comprised of at least one siphon pipe, and an end of the siphon pipe abuts the bottom of the lower-layer reaction area, and the other end of the siphon pipe is extended from a mid-high position of the lower-layer reaction area and then bent for at least once and passed through the bottom wall of the reaction container, and finally extended to the outside of the reaction container.

11. The automatic feeding apparatus of claim 10, wherein the siphon pipe is passed out from an end of the bottom wall of the reaction container and perpendicular to the bottom wall.

12. The automatic feeding apparatus of claim 10, wherein the dosing container has an outlet end installed with a flow control valve.

13. The automatic feeding apparatus of claim 10, wherein the water inlet is installed at a mid-high position of a sidewall of the lower-layer reaction area, and the position of the water inlet is higher than the highest bending point of the siphon pipe, and the water inlet has a water inlet pipe and a water regulating valve installed thereon.
